(19) United States
(12) Patent Application Publication
(10) Pub. No.: US 2025/0328920 A1
(43) Pub. Date: Oct. 23, 2025

(54) INFORMATION PROCESSING DEVICE

(71) Applicant: TOYOTA JIDOSHA KABUSHIKI KAISHA, Toyota-shi (JP)

(72) Inventors: Hiroyuki ISHII, Nisshin-shi (JP); Akihiko SHIBATA, Nisshin-shi (JP)

(73) Assignee: TOYOTA JIDOSHA KABUSHIKI KAISHA, Toyota-shi (JP)

(21) Appl. No.: 19/087,803

(22) Filed: Mar. 24, 2025

(30) Foreign Application Priority Data
Apr. 22, 2024 (JP) 2024-069355

(51) Int. Cl. G06Q 30/018; G06Q 50/06

(52) U.S. Cl. CPC G06Q 30/018; G06Q 50/06

(57) ABSTRACT

An information processing device according to an aspect of the present disclosure acquires a remaining amount of an improvement credit for improving a value of an impact indicator on an environment held by an object corporation. Then, the information processing device distributes at least a part of the remaining amount of the acquired improvement credit to each of the accounts of the one or more corporations that supply each of the one or more inclusive products included as one or more upstream products to the object product of the object corporation, which is specified by tracing a product tree hierarchically indicating a supply relationship of the product group including the object product of the object corporation in the supply chain to which the object corporation belongs.

### CROSS-REFERENCE TO RELATED APPLICATION

This application claims priority to Japanese Patent Application No. 2024-069355 filed on Apr. 22, 2024, incorporated herein by reference in its entirety.

### BACKGROUND

### 1. Technical Field

The present disclosure relates to an information processing device.

### 2. Description of Related Art

Japanese Unexamined Patent Application Publication No. 2004-171146 (JP 2004-171146 A) proposes a data communication system among corporations. Specifically, in the proposed system, a supply chain made up of a plurality of corporations, and a management server that performs data management among the corporations making up the supply chain, are connected via communication lines. The management server includes a contract database, a traded products database, and a trading condition database. The management server is configured to search for individual information of a vendor side and a customer side stored in the trading condition database using a contract-unique ID as a key, and to perform code translation of the individual information.

### SUMMARY

It is an object of the present disclosure to provide technology for reducing time and effort of improvement credit transactions.

An aspect of the present disclosure provides an information processing device including a control unit. The control unit is configured to execute acquiring of a remaining amount of improvement credit held by an object corporation, for improving a value of an impact indicator regarding an environment, and distributing of at least part of the remaining amount of the improvement credit that is acquired to an account of each of one or more corporations that supply each of one or more inclusion products included as one or more upstream-side products in an object product of the object corporation, the upstream-side products being identified by following a product tree that hierarchically indicates a supply relation of a product group containing the object product of the object corporation in a supply chain to which the object corporation belongs.

According to the present disclosure, time and effort of improvement credit transactions can be reduced.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 schematically illustrates an example of a scene to which the present disclosure is applied;

FIG. 2 illustrates an example of a method of dispensing a balance of improvement credits of the present disclosure;

FIG. 3 illustrates an example of a first method of referencing a product tree of the present disclosure;

FIG. 4 illustrates an example of a second method of referencing a product tree of the present disclosure;

FIG. 5 is a flowchart illustrating an example of a process for accepting a distribution condition according to the information processing device of the present disclosure. and

FIG. 6 is a flowchart illustrating an example of a processing procedure related to distribution of improvement credits by the information processing device according to the present disclosure.

### DETAILED DESCRIPTION OF EMBODIMENTS

In recent years, for example, there has been a change in social responsibility of corporations, such as the control of global warming. Such social responsibilities are difficult to address by a single corporation. Corporations in the supply chain must respond to social responsibility. Therefore, the development of the technology to visualize the supply relation of the product group from the final product of the most downstream corporation in the supply chain to the most upstream product of the most upstream corporation is proceeding. For example, JP 2004-171146 A proposes a technique for facilitating communication between corporations in a supply chain. Techniques for visualizing supply relationships of product groups have been developed in various fields. For example, in an effort such as Catena-X, MOBI, a technique for visualizing a supply relation of a product group in a supply chain of batteries is being developed.

One of the objectives of visualizing the supply relationship of a product group in the supply chain is to measure the value of the environmental impact indicator in the final product and to prove the correspondence to the above social responsibility. Environmental impact indicators are, for example, carbon dioxide emissions, the extent of use of renewable energy, etc. As an example, in Europe, a system for reporting carbon dioxide emissions over the life cycle of a battery is being developed. As one of the measures for improving the value of the impact indicator on the environment, for example, credit such as carbon credits is being introduced. However, if each corporation in the supply chain conducts a credit transaction individually, the credit transaction takes time and effort.

On the other hand, the information processing device according to the first aspect of the present disclosure includes a control unit. The control unit acquires the remaining amount of the improvement credit for improving the value of the impact indicator to the environment held by the object corporation, and

To distribute at least a part of the balance of the acquired improvement credit to each account of one or more corporations which supply each of one or more inclusion products included as one or more upstream products in the object product of the object corporation specified by following the product tree which shows hierarchically the supply relation of the product group containing the object product of an object corporation in the supply chain to which an object corporation belongs
It is configured to perform.
According to the first aspect of the present disclosure, it is possible to distribute the remaining amount of the improvement credit according to the supply relationship of the product group in the supply chain. Accordingly, it is possible to expect a reduction in the time and effort of the transaction of the improvement credit.

As another aspect of the information processing device according to the above aspect, one aspect of the present disclosure may be an information processing method that realizes all or a part of each of the above-described constituent elements. Another aspect of the present disclosure may be a program or a machine-readable storage medium such as a computer storing such a program. Here, the machine-readable storage medium is a medium that stores information such as a program by electrical, magnetic, optical, mechanical or chemical action.

### 1 Application Example

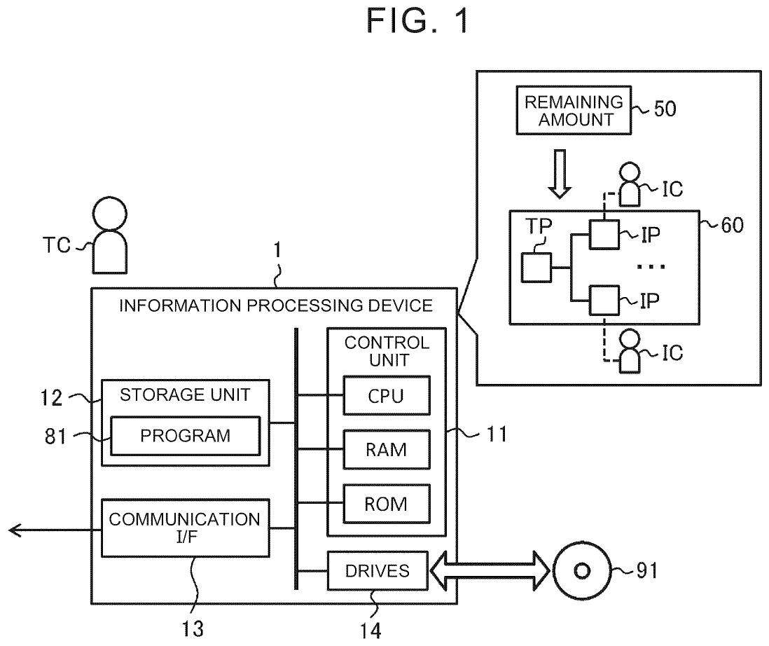

FIG. 1 schematically illustrates an example of a scene to which the present disclosure is applied. The information processing device 1 according to the present embodiment is one or more computers configured to execute a process of distributing the improvement credits held by the object corporation.

In the present embodiment, the information processing device 1 acquires the remaining amount 50 of the improvement credit for improving the environmental impact indicator held by the object corporation TC. The information processing device 1 distributes at least a part of the remaining amount 50 of the acquired improvement credits to the accounts of each of the one or more corporation IC that supplies each of the one or more inclusion product IP included as one or more upstream products to the object product TP of the object corporation TC. The accounts are identified by tracing a product tree 60 that hierarchically indicates the supply relation of the product group including the object product TP of the object corporation TC in the supply chain to which the object corporation TC belongs. In the supply chain, the corporation IC is the upstream corporation for the object corporation TC. Distributing at least a portion of the remaining amount 50 of improvement credits may improve the impact indicators of each of the one or more inclusion product IP. According to the present embodiment, it is possible to distribute the remaining amount 50 of the improvement credit according to the supply relationship (product tree 60) of the product group in the supply chain. Accordingly, it is possible to expect a reduction in the time and effort of the transaction of the improvement credit.

### Improvement Credit

Improvement credits are used to improve the value of the environmental impact indicator. The impact indicator on the environment is not particularly limited, and may be appropriately defined according to the embodiment. The environmental impact indicators may include, for example, emissions of carbon dioxide, the extent of use of renewable energy, etc. Known indicators may be used as impact indicators of environmental impact. Typically, improvement credits may be introduced to offset the shortfall of such environmental indicators with only the corporation's efforts. Improvement credits may be an object of commerce.

In an example of the present embodiment, the environmental impact indicator may include an emission amount of carbon dioxide. In response, the improvement credit may include carbon credits. This carbon credit may be used to reduce the number of carbon dioxide emissions in the corporation in which it is applied. According to an example of the present embodiment, it is possible to reduce the time and effort of the transaction when the carbon credits are traded.

In addition, in an example of the present embodiment, the environmental impact indicator may include a degree of use of renewable energy. The degree of use may be defined, for example, by ratio, total amount, etc. In response, the improvement credit may include renewable energy credits. This renewable energy credit may be used to increase the degree of renewable energy indicators in the corporation to which it applies. According to an example of the present embodiment, it is possible to reduce the time and effort of the transaction in a situation where credits of renewable energy are traded.

### Object Products

In the supply chain, the most downstream corporations provide end products. From this end product (the most downstream corporation) to the raw material (the corporation that provides the raw material) is from the downstream to the upstream. Out of the two corporations adjacent in the upstream and downstream direction of the supply chain, the corporation that provides products is the upstream corporation, and the corporation that receives products is the downstream corporation. For example, in the case of corporations upstream of corporation Z, “corporation Z” is a downstream corporation, and in the case of corporations downstream of corporation Z, “corporation Z” is an upstream corporation. Thus, “upstream” and “downstream” indicate relative relationships, and the designations of “upstream corporation” and “downstream corporation” may vary depending on the positional relationship within the supply chain. When “upstream corporation” is referred to as a Tier N corporation, “downstream corporation” is referred to as a Tier N−1 corporation (N is equal to or greater than 1).

In addition, the most upstream corporations in the supply chain provide products that do not go upstream any further. The most upstream corporation is, for example, a mining company for minerals. The corporations that exist between the upstream and downstream corporations in the supply chain are intermediate corporations, and the products provided by the intermediate corporations (i.e., the products between the final product and the upstream product) are intermediate products. Typically, an intermediate corporation processes one or more upstream products provided by its upstream corporation and provides the resulting products to its downstream corporation. Processing may include assembly, etc. However, not all corporations in the supply chain are corporations involved in such processing. The supply chain may include a corporation (e.g., a trading corporation) that does not process and wholesales upstream products directly to downstream corporations. The number of tiers of the supply chain is not particularly limited, and may be appropriately determined according to the embodiment.

The object product TP may be arbitrarily selected from products other than the most upstream products of the most upstream corporation among products provided in the supply chain. For example, the object corporation TC may be the most downstream corporation, and accordingly the object product TP may be the final product. Also, for example, the object corporation TC may be an intermediate corporation, and accordingly, the object product TP may be an intermediate product. On the other hand, the inclusion product IP is a product one or more upstream of the object product TP. The inclusion product IP may be an intermediate product or a most upstream product. The corporation IC is one or more upstream of the object corporation TC. At least some of the one or more corporation IC may be a direct upstream corporation (one upstream corporation) of the object corporation TC. Alternatively, all corporation IC may be two or more corporations upstream of the object corporation TC.

The value of the impact indicator for Product A is derived by integrating the values of the impact indicator for each of the one or more upstream products included in Product A and the values of the impact indicator for only Product A. For example, for carbon dioxide emissions, the emissions of Tier N−1 can be calculated by Equation 1 below.

$$( Mathematical formula 1 )$$

$$Emissions of Tier N - 1 products = Emissions of Tier N - 1 measurement for products + {\sum }_{k} ( k ( Tier N ) Product Emissions \times Usage in Tier N - 1 Product {u}_{k} ) \qquad ( Equation 1 )$$

By setting Tier N as the upstream corporation and repeating the computation of Equation 1 until Tier N−1 reaches the object corporation TC, the emission of the object product TP can be calculated. In one example, the upstream corporation shares its emissions with its downstream firm (one downstream firm). One downstream corporation calculates its own product emissions from the emissions shared by the most upstream corporations and from its own. One downstream corporation shares the calculated emissions of its products with another downstream corporation (two downstream corporations in view of the most upstream corporation). By taking over (repeating) this series of computations (sharing of emissions by upstream corporations, and integrating shared emissions with corporation emissions) until they reach the object corporation TC, it is possible to calculate emissions for the object product TP. The calculation of the integration can be changed to the calculation according to the impact indicator, and basically, the values of the other impact indicators can be derived in the same manner.

### Distribution Method

The condition for distributing the remaining amount 50 of the improvement credit is not particularly limited, and may be appropriately determined according to the embodiment. Dispensing conditions may be defined to define the manner of dispensing, e.g., range, total dispense, individual dispense, etc. The distribution condition may be specified by a user such as an operator, or may be uniquely set in a program (a program 81 described later) of the information processing device 1. The method of specifying the condition of distribution is not particularly limited, and may be appropriately selected according to the embodiment.

In an exemplary embodiment, one or more corporations upstream of the object corporation TC may be candidates for distributing at least a portion of the remaining amount 50 of the improvement credits from the object corporation TC. Among the one or more upstream corporations, IC of corporations that distribute the improvement credits (i.e., the extent to which the remaining amount 50 of the improvement credits is distributed) may be arbitrarily determined. All corporations one or more upstream may be an object of distribution, or corporations selected from among one or more upstream corporations may be an object of distribution. When a distribution object is selected from among one or more upstream corporations, any method of selecting a corporation to be distributed may be adopted, for example, randomly selecting a corporation that satisfies a specified condition. In one embodiment, a hierarchy (Tier1, Tier2 or the like) may be designated as a condition regarding the distribution scope, and a corporation belonging to the designated hierarchy may be selected as a distribution object (corporation IC). The hierarchy may be specified by an absolute value such as Tier1, Tier2, or may be specified by a relative value such as one upstream from the object corporation TC. In addition, as an example, a reference value of the impact indicator may be specified as a condition regarding the distribution range, and a corporation that supplies the inclusion product IP that satisfies or does not satisfy the specified reference value may be selected as the distribution object (corporation IC).

In addition, in the exemplary embodiment, the amount of the total improvement credits (total distribution amount) distributed to the accounts of one or more corporation IC among the remaining amount 50 of the improvement credits is not particularly limited, and may be appropriately determined according to the embodiment. All of the remaining amount 50 may be dispensed, or a portion of the remaining amount 50 may be dispensed. The distribution amount may be specified by an absolute value, or may be specified by a relative value, for example, half of the remaining amount 50.

In addition, in an exemplary embodiment, when a plurality of corporations become distribution objects (corporation IC), an amount (individual distribution amount) for distributing at least a part of the remaining amount 50 of the improvement credits to the respective corporations is not particularly limited, and may be appropriately determined according to the embodiment. In one example, the individual doses may be defined by a ratio. The ratio to be distributed to each corporation may be set to, for example, an equal ratio, a weighted ratio, or the like. The individual dispensing amounts may be defined as relative values or absolute values, as described above. In addition, the individual distribution amounts may be defined at the same time as each corporation, or may be defined in order of priority. For example, improvement credits may be distributed in descending order of priority, and the remainder may be distributed to the last corporation. The individual distribution amounts may be defined according to attributes such as the hierarchy to which each corporation belongs, the value of the impact indicator, and the like.

In an example, the information processing device 1 may be configured to receive a designation of a condition for distributing the improvement credit. In response, distributing at least a portion of remaining amount 50 of the improvement credit may be configured by distributing at least a portion of the remaining amount 50 of improvement credit according to specified conditions. The specifiable conditions may include at least any of the conditions relating to the distribution range, the conditions relating to the total distribution volume, and the conditions relating to the individual distribution volumes. According to an exemplary embodiment of the present disclosure, it is possible to control the distribution amount of the improvement credits to the corporation IC that supplies the inclusion product IP.

The specification of the distribution criteria may be inputted by an operator of the object corporation TC. The operator of the object corporation TC may enter the conditional designation in any manner. For example, in a case where the information processing device 1 is accessed using a terminal, the operator may input a distribution condition via the terminal. Further, for example, when the input device and the output device are connected to the information processing device 1, the operator may input the distribution condition using the input device and the output device.

Also, in one instance, the specified terms may include distributing more improvement credits as the corporation IC's accounts that provide the inclusion product IP for which the impact indicator is worse. In one example, the individual dispensed quantities may be determined according to a ratio as a function of the value of the impact indicator. For example, if the higher the value of the impact indicator, such as the emission of carbon dioxide, indicates a worse environment, the individual distribution may be determined to be proportional to the value of the impact indicator. Also, for example, when a higher value of the impact indicator indicates that the environment is better, such as the degree of use of renewable energy, the individual distribution amount may be determined to be inversely proportional to the value of the impact indicator. However, the distribution method for determining a larger amount of distribution as the value of the impact indicator is worse may not be limited to such an example as long as the relation is satisfied in at least a part of the corporation IC that is an object of distribution, and may be appropriately changed according to the embodiment. In another example, the individual distribution amounts may be determined according to the rank to which the value of the impact indicator belongs. According to an exemplary embodiment of the present disclosure, it is possible to reduce the probabilities of the presence of the inclusion product IP having a bad value of the impact indicator by distributing at least a part of the remaining amount 50 of the improvement credits as the account of the corporation IC that supplies the inclusion product IP having a bad value of the impact indicator is. As a consequence, it is possible to expect to avoid the adverse effects caused by the inclusion of IP of the adverse impact indicator.

It should be noted that the larger the number of improvement credits is distributed as the number of accounts of the corporation IC that supplies the inclusion product IP whose impact indicator is bad may be satisfied by at least a part of the corporation IC that is the object of distribution. In other words, there may be cases where, among at least some corporation IC, the quantity of improvement credits to be distributed to the corporation IC that supplies the inclusion product IP with the negative value of the impact indicator is larger than the quantity of the corporation IC that supplies the inclusion product IP with the good value of the impact indicator. In this situation, it may be considered that the accounts of the corporation IC that provide the inclusion product IP with the worse impact indicator are satisfied with the configuration that distributes the more the improvement credits.

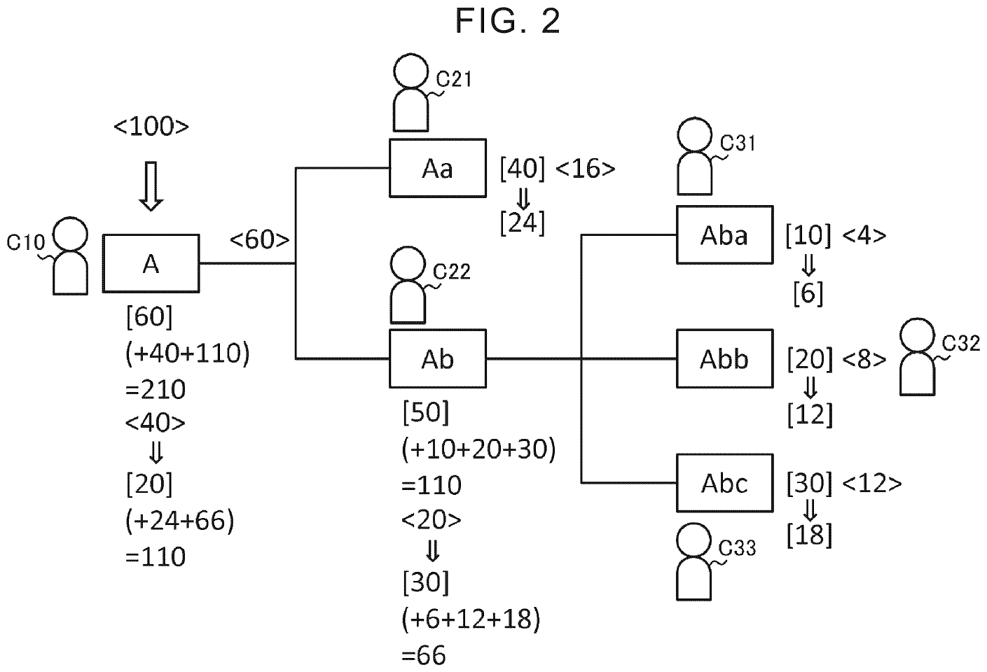

FIG. 2 shows an example of a method for distributing the remaining amount 50 of improvement credits according to the present embodiment. In the example of FIG. 2, the larger the value, such as the emission amount of carbon dioxide, the worse the environment. The value of the corporation's product is derived from the cumulative value of the corporation's own value and the value of the upstream product (Equation 1 above), and the improvement credits assume the situation where the impact indicator used for subtraction is adopted. Product A includes product Aa and product Ab as products supplied by one upstream corporation. The product Ab includes a product Aba, a product Abb, and a product Abc as products supplied from one upstream corporation. Product Aa, product Aba, product Abb and product Abc are the most upstream products. That is, in this situation, five candidates for the inclusion product IP included in product A as products at one or more upstream are product Aa, product Ab, product Aba, product Abb, and product Abc. Product A, Product Aa, Product Ab, Product Aba, Product Abb, and Product Abc are supplied by each of the corporation C10, corporation C21, corporation C22, corporation C31, corporation C32, and corporation C33. Impact indicators for product Aba, product Abb, and product Abc are [10], [20], and [30], respectively. The impact indicator of Aa is [40]. The value of the impact indicator of the product Ab is calculated as “110” by summing the value [50] of the product Ab itself and the value ([10], [20], [30]) of the impact indicator of the upstream product (product Aba, product Abb, product Abe). The value of the impact indicator of the product A is calculated as “210” by summing the value [60] of the product A itself and the value ([40], [110]) of the impact indicator of the upstream product (product Aa, Ab). The product A is an example of the object product TP, and the corporation C10 that supplies the product A is an example of the object corporation TC. Five products (product Aa, product Ab, product Aba, product Abb, and product Abc) are all assumed to be selected for inclusion product IP. That is, C21, C22, C31, C32, C33 provides one or more upstream corporation IC that provide an inclusion product IP. The corporation C10 holds <100> improvement credits. <100> is an example of the remaining amount 50. The corporation C10 assumes that <40> in this <100> is used to improve the value of product A itself, and that the remaining <60> is distributed in proportion to the value of the respective inclusion product IP.

In the scenario of FIG. 2, the improvement credits <60> are distributed proportionally, so that the improvement credits of quantities (<16>, <20>, <4>, <8>, <12>) proportional to the respective values are distributed to the respective products (product Aa, product Ab, product Aba, product Abb, and product Abc) of the respective corporations (C21, C22, C31, C32, C33). This distribution improves the impact indicator of each product (product Aa, product Ab itself, product Aba, product Abb, product Abc) to [24], [30], [6], [12] and [18]. The impact indicator of Ab is improved from “110” to “66” (30+6+12+18=66). The value of the Impact Indicator for Product A is improved from “210” to “110” (20+24+66=110) because it uses a total of <100> improvement credits. As described above, by distributing the remaining amount 50 of the improvement credits, the value of the impact indicator of the object product TP can be improved, and the value of the impact indicator of the respective inclusion product IP can also be improved. It should be noted that, in the distribution method of FIG. 2, if the sum of the inclusion product IP is specified in the object corporation TC, the distribution amounts to be distributed to the respective inclusion product IP can be specified. Therefore, this distribution method is easy to calculate.

These condition settings are merely examples, and the present disclosure is not limited to these condition settings. Further, as described above, the distribution method is not limited to the proportional distribution illustrated in FIG. 2, and may be appropriately changed according to the embodiment. In another example, the improvement credits may be distributed evenly. In the example of FIG. 2, when <60> is evenly distributed, the improvement credits of <12> are distributed to the respective products (product Aa, product Ab itself, product Aba, product Abb, and product Abc). Aba will then distribute improvement credits in amounts (<12>) that exceed the original [10]. The excess of the dispensed amount may optionally be handled. The excess may be granted directly to the accounts of the corporation to be distributed (in the above-described scenario, the corporation C31) or may be redistributed to other items. The redistribution may be performed in any manner. For example, the excess may be distributed to accounts of the downstream corporation (in the above scenario, the corporation C22) of the corporation to be distributed.

Note that the account of each corporation may be managed as account information. The value of the impact indicator of each product may be held in the product information of each product. The remaining amount of the improvement credit held by each account may be held as credit information. The process of distributing the improvement credits may be configured by updating at least one of the credit information and the product information associated with each account. In one embodiment, the distribution source (object corporation TC) may update the credits associated with the accounts of the object corporation TC by subtracting the remaining amount 50 by the distribution amount. On the other hand, in the distribution destination (corporation IC), the credit information or the product information associated with the accounts of the corporation IC may be updated by adding the remaining amount to be held by the distribution amount or applying the distribution amount to the value of the impact indicator. These pieces of information processing may be executed by the information processing device 1 or may be executed by an external computer in response to an instruction from the information processing device 1. Further, at least a part of the account information, the credit information, and the product information of each corporation may be held in a memory resource of the information processing device 1 or may be held in an external computer other than the information processing device 1. The same applies to the information of the improvement credits and the product information. As a method of managing the account information or the like, a known method relating to the management of the account may be adopted.

### Product Tree

The product tree 60 is configured to hierarchically indicate a supply relationship of at least a part of the product group from the most upstream product to the final product. The object product TP may be a final product or an intermediate product included in the product group visualized in the product tree 60. The inclusion product IP may be a product one or more upstream of the object product TP, and may be an intermediate product or a most upstream product included in the product group visualized in the product tree 60. In one example, information (tree information) indicating the product tree 60 may be configured by product information of each product and association information between products. In addition, in an example, the tree information may be held as integral information or may be held in a distributed manner for each corporation. When the information is held as integral information, the information processing device 1 may refer to the tree information to grasp the structure of the product tree 60 to which the object product TP belongs at a time, and execute the information processing related to the distribution. On the other hand, in the case of being held in a distributed manner, the information processing device 1 may access the information held in a distributed manner in a stepwise manner and execute the information processing related to the distribution. In an example of the present embodiment, the information processing device 1 may execute a process of distributing the improvement credits with reference to the information held in a distributed manner by any of the following two methods.

### (A) First Method

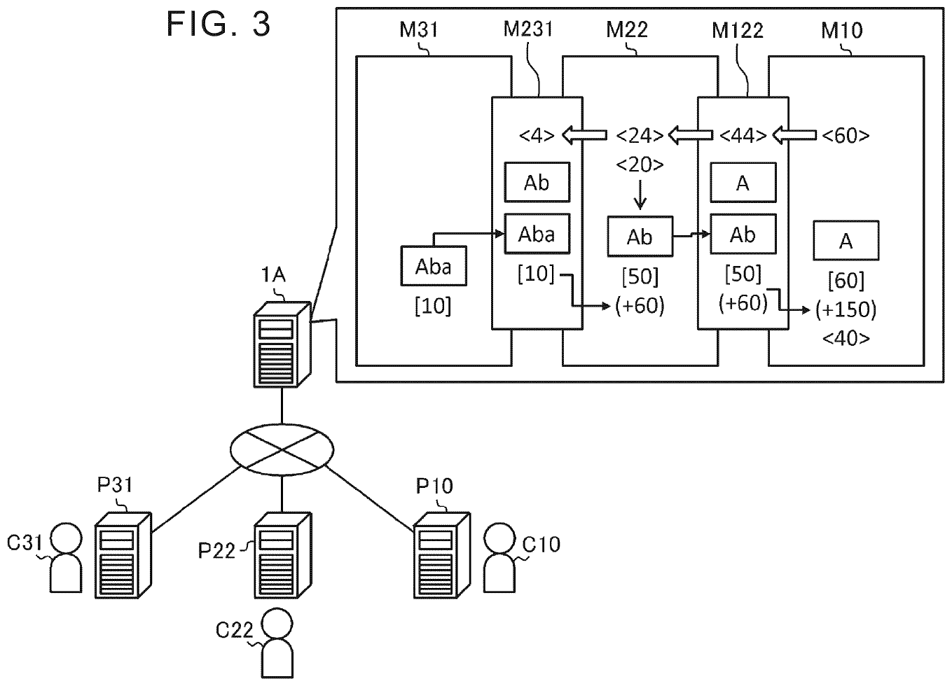

FIG. 3 shows an example of the first method of referring to the product tree 60 according to the present embodiment. In one embodiment of FIG. 3, the server-device 1A is configured to manage account-information, product-information, association-information, and credit-information of the respective corporations. The server device 1A is an exemplary information processing device 1. corporations use terminals to access the server-device 1A. Each corporation's account is provided with a dedicated storage area. The dedicated storage area is configured to be accessible only to the account of the corresponding corporation. Further, a storage area used for sharing information is further provided between the accounts of the corporation. Each storage area may be provided in a memory resource of the information processing device 1 or may be provided in an external computer other than the information processing device 1.

As the premise of each corporation, the scene shown in FIG. 2 is assumed. Of the six corporations, the corporation C10, the corporation C22, and the corporation C31 are represented and illustrated. Each corporation (C10, C22, C31) uses each terminal (P10, P22, P31) to access the server-device 1A. Each corporation (C10, C22, C31) is provided with a dedicated storage area (M10, M22, M31). In each dedicated storage area (M10, M22, M31), product information such as identification information of a product (A, Ab, Aba) of each corporation (C10, C22, C31), and a value of an impact indicator may be stored. A shared storage area M231 is provided between the corporation C31 and the corporation C22, and a shared storage area M122 is provided between the corporation C22 and the corporation C10. The corporation C31 can share the identity of the product Aba and the impact indicator [10] with the corporation C22 via the storage area M231. The corporation C22 can acquire the impact indicator of the upstream product through the shared storage area (including the storage area M231) with the upstream corporation. Further, by integrating the obtained value (the sum of 60) into the value [50] of the product Ab itself, the corporation C22 can calculate the value of the impact indicator of the product Ab (“110”). The corporation C22 can share the identification information of the product Ab and the value “110” (integrated result) of the impact indicator with the corporation C10 via the storage area M122. The corporation C10 can acquire the impact indicator of the upstream product through the shared storage area (including the storage area M122) with the upstream corporation. By integrating the obtained value (sum 150) into the value [60] of the product A itself, the corporation C10 can calculate the value of the impact indicator of the product A (“210”).

In the shared storage area, the identification information of the downstream product may be further shared. For example, in the storage area M231, the identification information of the product Ab may be shared, and in the storage area M122, the identification information of the product A may be shared. In the shared storage area, the association information may be generated by using the identification information of the upstream product and the downstream product, thereby forming the association relationship between the upstream product and the downstream product. As long as the upstream and downstream product relationships in the product tree 60 can be specified, the data format of the association information is not particularly limited, and may be appropriately determined according to the embodiment. Note that the value of the impact indicator of the downstream corporation does not need to be shared by the upstream corporation. As the data format of each storage area, any format such as a relational database and a blockchain base may be adopted.

In response to an operator's action, the corporation C10 terminal P10 may access the server device 1A, log in to the server device 1A using the account of the corporation C10, and then give an instruction to distribute the improvement credits to the server device 1A. In response to this, the server-device 1A may distribute the improvement credits to the respective corporation IC by propagating the distribution amounts upstream from the object corporation TC using the respective shared storage areas. In the example of FIGS. 2 and 3, when distributing proportionally, the server-device 1A may refer to the shared storage area between the corporation C10 and the upstream corporations (C21, C22), and determine the distribution amounts according to the impact indicators of the products (Aa, Ab) of the upstream corporations (C21, C22). The server-device 1A may write the assignment information for assigning the determined distribution amount to the shared storage areas. In FIG. 3, the storage area M122 shared with the corporation C22 is written with assignment data for assigning <44> corresponding to the product Ab “110”. The server device 1A writes the assignment information for assigning <20> corresponding to the value [50] of the product Ab itself among <44> to the dedicated storage area M22 of the corporation C22. This allows the corporation C22 to receive an improvement credit of <20>. In addition, the server device 1A refers to the shared storage area between the corporation C22 and the upstream corporations (C31, C32, C33), and executes the same process as described above. This allows the server-device 1A to distribute the improvement credits of <24> remaining to the respective upstream corporations (C31, C32, C33).

When the server device 1A is configured to manage product-information, a shared storage area may not necessarily be provided. Each dedicated storage area may be configured to accept writing of information from another corporation other than the corresponding corporation, for example, by a method such as a public key cryptosystem. In FIG. 3, the corporation C31 may write the information of the product Aba into the storage area M22 by using an electronic certificate (public key or the like) issued by the corporation C22. The corporation C22 may use the electronic certificate issued by the corporation C10 to write the information of the product Ab to the storage area M10. Thus, the information may be shared between the corporations. When a blockchain base is adopted as the storage area, a smart contract may be used for writing this information.

### (B) Second Method

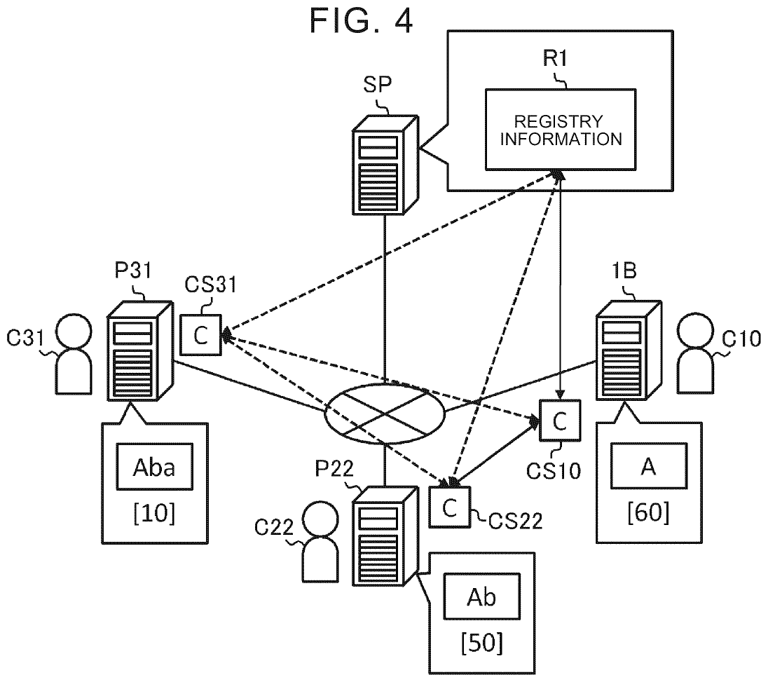

FIG. 4 illustrates an example of a second method of referring to the product tree 60 according to the present embodiment. In the example of FIG. 4, the product information of each corporation is managed by a terminal of each corporation. The server-device SP manages registry-information R1 for data-linking among corporations. The registry information R1 may include connection information such as connection destinations (address information) and authentication information of terminals of respective corporations. The registry information R1 may be configured by, for example, pre-existing information such as a digital twin registry. The registry information R1 can be used by a terminal of a corporation to perform data cooperation with a terminal of another corporation. In addition, a connector may be used for data cooperation between terminals of each corporation. The connector is software for data cooperation such as authentication. The connector may be configured by conventional software such as, for example, Eclipse Dataspace Connector (EDC).

As the premise of each corporation, the scene shown in FIG. 2 is assumed as in the first method. Similar to FIG. 3, among the six corporations, the corporation C10, the corporation C22, and the corporation C31 are represented and illustrated. The corporation C10 uses a terminal 1B in which a connector CS10 is installed. The terminal 1B is an exemplary information processing device 1. In the terminal 1B, the product information of the product A is managed. Each corporation (C22, C31) uses each terminal (P22, P31) in which a connector (CS22, CS31) is installed. In each terminal (P22, P31), product data of each product (Aba, Ab) is managed.

The terminal 1B of the corporation C10 may refer to the registry-information R1 of the server device SP in response to an operation by the operator, and perform data-cooperation with the terminal (including the terminal P22) of the upstream corporation. Through this linkage, the terminal 1B may acquire the identification information of the upstream product (Aa, Ab) and the impact indicator value. The terminal 1B may further acquire information of an upstream corporation (C31, C32, C33) in the data-cooperation with the terminals of the respective upstream corporations. The terminal 1B refers to the registry information R1 by using the acquired information as a key, and further performs data cooperation with a terminal (including a terminal P31) of an upstream corporation to acquire identification information and an impact indicator of an upstream product (Aba, Abb, Abc). Alternatively, the terminal P22 of the corporation C22 may perform data cooperation with the terminals of the respective upstream corporations (C31, C32, C33) in the same manner as the terminal 1B, and collect the identification information and the impact indicator of Aba, Abb, Abc through the data cooperation. In this case, the terminal 1B may also acquire Aba, Abb, Abc in the data-cooperation with the terminal P22 of the corporation C22. Information of the product tree 60 may be collected through data collaboration with each of such corporations. The obtained information of the product tree 60 may be held in the terminal 1B or may be held as a registry information R1.

The operator of the corporation C10 may execute the distribution of the improvement credits by operating the terminal 1B using the obtained product tree 60. The assignment information for distributing the improvement credits may be notified in data cooperation between the terminals. In an exemplary embodiment, the terminal 1B may notify Aa, Ab of each upstream corporation (C21, C22) via data linkage with a terminal of each upstream corporation (C21, C22). The assignment information of the corporation C22 to each upstream corporation (C31, C32, C33) may be notified in the data cooperation between the terminal 1B and each upstream corporation (C31, C32, C33) terminal. The information to be provided to each upstream corporation (C31, C32, C33) of the corporation C22 may be notified in the data cooperation between the terminal P22 of the corporation C22 and the terminals of each upstream corporation (C31, C32, C33). This allows the corporation C10 to distribute improvement credits to the respective corporations (C21, C22, C31, C32, C33).

### Two Configuration Examples

In the example of FIG. 1, the information processing device 1 according to the present embodiment is a computer in which a control unit 11, a storage unit 12, a communication interface 13, and a drive 14 are electrically connected to each other.

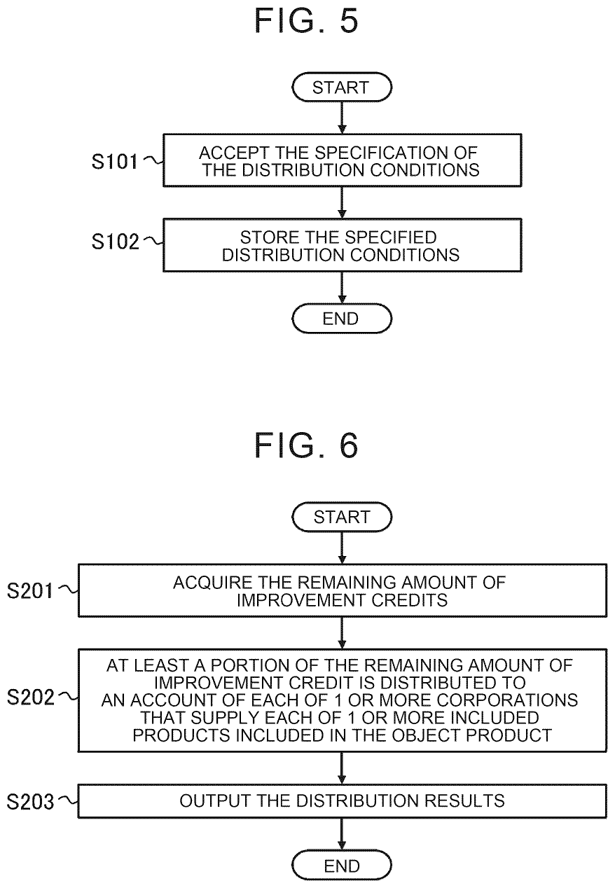

The control unit 11 includes Central Processing Unit (CPU), Random Access Memory (RAM), Read Only Memory (ROM), and the like, and is configured to execute any information processing based on programs and various types of data. The control unit 11 (CPU) is an exemplary processor resource. The storage unit 12 may be constituted by an arbitrary storage device such as a hard disk drive or a solid state drive, for example. The storage unit 12 (and RAM, ROM) is an exemplary memory-resource. In the present embodiment, the storage unit 12 stores various kinds of information such as the program 81. The program 81 is a program for causing the information processing device 1 to execute the information processing related to the distribution of the improvement credits (FIGS. 5 and 6 described later). The program 81 includes a series of instructions for the information processing. The communication interface 13 is configured to perform wired or wireless data communication via a network. The communication interface 13 may be configured by, for example, a wired Local Area Network (LAN) module, a wireless LAN module, or the like. In the present embodiment, the information processing device 1 may perform data communication with another computer via a network using the communication interface 13. The drive 14 is a device for reading various kinds of information such as a program stored in the storage medium 91. The program 81 may be stored in the storage medium 91 in place of the storage unit 12 or together with the storage unit 12. The storage medium 91 is configured to store various kinds of information (such as stored programs) by electrical, magnetic, optical, mechanical or chemical action so that a machine such as a computer can read the information. The information processing device 1 may acquire the program 81 from the storage medium 91. Note that the storage medium 91 may be a disk-type storage medium such as a CD, DVD, or may be a storage medium other than a disk-type such as a semiconductor memory (for example, a flash memory). The type of the drive 14 may be appropriately selected according to the type of the storage medium 91.

Regarding the specific hardware configuration of the information processing device 1, it is possible to omit, replace, and add constituent elements as appropriate according to the embodiment. For example, the control unit 11 may include a plurality of hardware processors. The hardware processor may include a microprocessor, a field-programmable gate array (FPGA, a digital signal processor (DSP, an Electronic Control Unit (ECU, a Graphics Processing Unit (GPU, an application specific integrated circuit (ASIC, and the like. The drive 14 may be omitted. The information processing device 1 may further include an input device and an output device. The input device may include, for example, a mouse, a keyboard, an operator, a microphone, and the like. The output device may include, for example, a display, a speaker, etc. The input device and the output device may be integrally formed of, for example, a touch panel display or the like. The operator can operate the information processing device 1 by using the input device and the output device. The input device and the output device may be connected via an external interface. The external interface may be appropriately configured to be connected to an external device by, for example, a Universal Serial Bus (USB) port, a dedicated port, or the like, by a wire or wirelessly. The drive 14 may be connected via an external interface. The information processing device 1 may be a general-purpose server device, a general-purpose Personal Computer (PC, or the like, in addition to a computer designed for service-dedicated services to be provided.

### 3 Operation Example

FIG. 5 is a flowchart illustrating an example of a processing procedure related to acceptance of a distribution condition by the information processing device 1 according to the present embodiment. FIG. 6 is a flowchart illustrating an example of a processing procedure related to distribution of improvement credits by the information processing device 1 according to the present embodiment. The control unit 11 of the information processing device 1 executes a command included in the program 81 by a CPU. Accordingly, the information processing device 1 operates as a computer capable of executing the information processing of FIGS. 5 and 6 described below. The following processing procedure is an example of an information processing method executed by a computer. However, the following processing procedure is merely an example, and each step may be changed as much as possible. Further, the following processing procedures can be omitted, replaced, and added as appropriate according to the embodiment.

### Acceptance of Distribution Conditions

As illustrated in FIG. 5, in S101, the control unit 11 accepts the designation of the condition for distributing the improvement credits. In one instance, the terms may include distributing more improvement credits as the corporation IC's accounts providing the inclusion product IP with a worse impact indicator. Upon receiving the designation of the distribution conditions, the control unit 11 advances the process to the following S102.

In S102, the control unit 11 stores the specified distribution criteria. In one embodiment, the setting information indicating the distribution condition may be stored in any storage area such as RAM, the storage unit 12, the storage medium 91, and an external storage device (external computer). The control unit 11 may update the setting data in accordance with the designation in S101 as S102 storage process.

When the designated distribution condition is stored, the control unit 11 ends the processing procedure related to acceptance of the distribution condition according to the present operation example. The control unit 11 may appropriately execute a series of processes of S101 and S102 in response to a request from an account (operator manipulation) of the object corporation TC. Note that S101 and S102 processes may be omitted when the configuration is not configured to accept the designation of the distribution conditions.

### Distribution of Improvement Credits

As illustrated in FIG. 6, in S201, the control unit 11 acquires the remaining amount 50 of the improvement credits held by the object corporation TC. In one example, the environmental impact indicator may include carbon dioxide emissions, and the improvement credit may include carbon credits. Also, in one example, the environmental impact indicator may include a degree of use of renewable energy, and the improvement credit may include a credit of renewable energy. When the remaining amount 50 is acquired, the control unit 11 advances the process to the following S202.

In S202, the control unit 11 distributes at least a portion of the remaining amount 50 of the acquired improvement credits to the accounts of each of the one or more corporation IC that provide each of the one or more inclusion product IP identified by following the product tree 60. In one embodiment, the control unit 11 may distribute at least a portion of the acquired remaining amount 50 of the improvement credits to the accounts of the corporation IC in accordance with the criteria specified by S101. When the distribution of the improvement credits is completed, the control unit 11 advances the process to the following S203.

In S203, the control unit 11 outputs information related to the distribution result. The configuration and the output destination of the information regarding the distribution result may be appropriately selected according to the embodiment. The information about the distribution result may include information indicating that the distribution has been performed (i.e., the distribution has been completed). The information about the distribution outcome may include information indicating the quantity of improvement credits distributed to the inclusion product IP of the corporation IC. The information about the distribution outcome may include information indicating the remaining amount of the improvement credits held by the object corporation TC after the distribution. The destination may be selected from a RAM, a storage unit 12, a storage medium 91, an external storage device (external computer), and the like.

When the information on the distribution result is output, the control unit 11 ends the processing procedure related to the distribution of the improvement credit according to the present operation example. The control unit 11 may appropriately execute a series of processes from S201 to S203 in response to a request from an account (operator manipulation) of the object corporation TC.

### Features

According to the present embodiment, the process of S201 and S202 can distribute the remaining amount 50 of the improvement credits according to the supply relation (product tree 60) of the product group in the supply chain. Accordingly, it is possible to expect a reduction in the time and effort of the transaction of the improvement credit.

### 4 Modification

While embodiments of the present disclosure have been described in detail above, the foregoing description is merely illustrative of the present disclosure in all respects. The processing and units described in the present disclosure can be freely combined and implemented as long as there is no technical contradiction. Various modifications or variations may be made in the above-described embodiments as appropriate.

What is claimed is:

1. An information processing device comprising: a control unit that is configured to execute
acquiring of a remaining amount of improvement credit held by an object corporation, for improving a value of an impact indicator regarding an environment; and
distributing of at least part of the remaining amount of the improvement credit that is acquired, to an account of each of one or more corporations that supply each of one or more inclusion products included as one or more upstream-side products in an object product of the object corporation, the upstream-side products being identified by following a product tree that hierarchically indicates a supply relation of a product group containing the object product of the object corporation in a supply chain, to which the object corporation belongs.

2. The information processing device according to claim 1, wherein
the impact indicator regarding the environment includes carbon dioxide emissions, and
the improvement credit includes carbon credits.

3. The information processing device according to claim 1, wherein
the impact indicator regarding the environment includes a degree of use of renewable energy, and
the improvement credit includes credit for the renewable energy.

4. The information processing device according to claim 1, wherein
the control unit is configured to further execute accepting of specification of a condition for distributing the improvement credit, and
the distributing of at least part of the remaining amount of the improvement credit is made up of distributing at least part of the remaining amount of the improvement credit according to the condition that is specified.

5. The information processing device according to claim 4, wherein the condition includes distributing the improvement credit such that, poorer the value of the impact indicator of an inclusion product is, more of the improvement credit is distributed to an account of a corporation that supplies the inclusion product.
